(19) United States
(12) Patent Application Publication
(10) Pub. No.: US 2012/0259939 A1
(43) Pub. Date: Oct. 11, 2012

(54) CALCULATOR

(76) Inventors: Timothy James Wessman, Ft. Collins, CO (US); Cyrille de Brebisson, Chens sur Leman (FR)

(21) Appl. No.: 13/080,155

(22) Filed: Apr. 5, 2011

(51) Int. Cl. G06F 15/16

(52) U.S. Cl. 709/209; 709/250

(57) ABSTRACT

In one implementation, a calculator includes a first coupler, a second coupler, and a processor. The first coupler configured to form a complementary fit with a coupler of a first calculator. The second coupler configured to form a complementary fit with a coupler of a second calculator. The processor operatively coupled to the first coupler and to the second coupler.

### BACKGROUND

Calculators are devices that perform arithmetic operations. Typically, the arithmetic operations are specified by a user and a result of the arithmetic operations are provided to the user at a display or some other output device.

Some calculators include communications interfaces via which a calculator can communicate with another calculator. For example, a calculator can include a communications port that receives one endpoint of a cable. Another endpoint of the cable is received at a communications port of another calculator. The calculators can communicate one with another via the cable. As another example, a calculator can include a wireless communications port such as an Infrared Data Association (“IrDA”) interface and can communicate wirelessly with other calculators including an IrDA interface.

### BRIEF DESCRIPTION OF THE DRAWINGS

FIGS. 1A and 1B are illustrations of a calculator, according to an implementation.

FIG. 1C is an illustration of two calculators according to FIGS. 1A and 1B in a stacked configuration, according to an implementation.

FIG. 2 is a schematic block diagram of a calculator, according to an implementation.

FIG. 3 is a schematic block diagram of a calculator, according to another implementation.

FIGS. 4A and 4B are illustrations of a calculator, according to an implementation.

FIG. 4C is an illustration of two calculators according to FIGS. 4A and 4B in a stacked configuration, according to an implementation.

FIG. 5 is a flowchart of a process to access commands from a calculator configured as a master, according to an implementation.

FIG. 6 is a flowchart of a process to provide commands to a calculator configured as a slave, according to an implementation.

### DETAILED DESCRIPTION

A calculator is a device that performs arithmetic operations. For example, a calculator can be a hand-held electronic device that is used to perform arithmetic operations. Examples of such calculators include simple and inexpensive add/subtract/multiply/divide calculators, scientific calculators, financial calculators, and graphing calculators. Additionally, electronic devices such as cellular phones, smartphones, personal digital assistants (“PDAs”), media players such as MP3 or video players, and tablet or slate devices that host calculator software applications (i.e., software applications that perform arithmetic operations) are calculators.

Calculators are often used in a classroom environment to supplement manual (e.g., by students) computation of mathematic problems. For example, graphing calculators can be useful to help students visualize mathematic functions. Additionally, calculators can be useful to avoid tedious manual computation of long arithmetic operations (e.g., division of numbers with many significant figures). Furthermore, calculators are often used in testing environments, for example, to reduce the time used to compute trivial arithmetic operations.

However, the use of calculators in such environments can be complicated, for example, by the amount of time required to enter data sets such as mathematic functions, tables of numeric values, or other information into the calculators. Additionally, in a testing environment, some calculator functionalities may be allowed (e.g., addition, subtraction, multiplication, and division) and other functionalities may be prohibited (e.g., symbolic integration and stored data). Thus, some calculators are allowed (i.e., those calculators without the prohibited functionalities) for use in the testing environment and other calculators are banned (i.e., those calculators with the prohibited functionalities) from use in the testing environment.

Some calculators include wired or wireless communications interfaces. Calculators with a wired communications interface include a communications port into which one endpoint of a cable is inserted. Another endpoint of the cable can then be inserted into another calculator and the calculators can communicate via the cable. Calculators with a wireless communications interface can communicate one with another without a cable. Typically, a calculator with a wireless communications interface can communicate with any other calculator with a wireless communications interface that is within the range (i.e., wireless signal propagation range) of the wireless communications interfaces of the calculators.

These communications interfaces, however, can be problematic. For example, in a classroom environment, to provide a data set to a group of calculators with wired communications interfaces, a teacher must separately connect his or her calculator to each of the calculators. Alternatively, each of the calculators must be connected to a common cable or communications network hub. In either example, a significant amount of time can be spent connecting and disconnecting the calculators. A further disadvantage of such interfaces is that the cables and hub must be provided.

A wireless communications interface can reduce the need to connect a cable to each calculator, but can be undesirable in a testing environment. Because calculators that communicate via wireless communications interfaces do so without cables, students in a testing environment can connect with other students via their calculators to share solutions, to request help, or to otherwise use their calculators in prohibited ways (or cheat).

Implementations discussed herein relate to calculators that communicate one with another via couplers (i.e., the calculators are physically rather than wirelessly coupled one to another) without cables. For example, calculators can include a coupler such as an electrically-conductive pad at a front face of the calculators and a coupler at a back face of the calculators. The calculators are then stacked one on top of another such that the couplers of adjacent calculators are coupled (e.g., in contact to form an electrical connection or are mechanically coupled) one to another. The top and bottom calculators in the stack are directly connected to one other calculator in the stack. The remaining calculators in the stack are each directly connected to two other calculators in the stack.

In addition to communicating with the calculators directly connected to each calculator, calculators can communicate with calculators in the stack to which they are not directly connected. For example, the two couplers of each calculator can be connected one to another (e.g., within that calculator) such that information (or signals representing data) that are applied to one coupler of that calculator are passed to the other coupler of that calculator. Thus, the couplers of each calculator in the stack forms or defines a common bus via which information is distributed to each calculator in the stack.

Alternatively, for example, each calculator can forward information received at one coupler of that calculator to the other coupler of that calculator. As a specific example, each calculator can include a device identifier. If a calculator receives a command (or a data packet including a command) that includes that calculator's device identifier, that calculator can process the command and not forward the command because the command was addressed to that calculator. If, however, a calculator receives a command that does not include that calculator's device identifier, that calculator can forward the command (e.g., send the command via the coupler at which the command was not received or via one or more other couplers) because the command was not addressed to that calculator. As an alternative, a calculator can forward each command it receives.

Because the calculators can communicate one with another when stacked, time can be saved in a classroom environment by avoiding connecting cables to each calculator and students are not able to communicate via wireless signals in a testing environment. As an example use of such calculators, students stack their calculators prior to a test and a teacher places his or her calculator at the top of the stack. The teacher then sends commands via his or her calculator to the students' calculators. For example, the teacher can send configuration commands to enable or disable functionalities of or access to files stored at each student's calculator, commands that include data sets to be used during an exam to each student's calculator, and commands to enable an operation history to track or monitor the operations used and functionalities accessed at each student's calculator. The students then retrieve their calculators and take the exam.

After the exam, the students again stack their calculators and teacher places his or her calculator at the top of the stack. The teacher sends commands via his or her calculator to the students' calculators. For example, the teacher can send, via the teacher's calculator, configuration commands to restore (i.e., enable or disable) functionalities of or access to files stored at each student's calculator to the state of those functionalities and access to files before the teacher's prior configuration commands, commands to delete the data sets uploaded earlier from each student's calculator, commands to disable the operation history, and commands to download the operation history to the teacher's calculator. Alternatively, functionalities of or access to files stored at each student's calculator can be restored to the state of those functionalities and access to files before the teacher's prior configuration commands, data sets can be deleted, and an operation history can be disabled after a time set by configuration commands provided by the teacher's calculator.

As used herein, the singular forms “a,” “an,” and “the” include plural referents unless the context clearly dictates otherwise. Thus, for example, the term “memory” is intended to mean one or more memories or a combination of memories. Additionally, as used herein, the term “module” refers to hardware, circuitry such as circuitry implementing computing logic, and/or software, firmware, programming, machine- or processor-readable instructions, commands, or code that are stored at a memory and executed or interpreted (or hosted) at a processor.

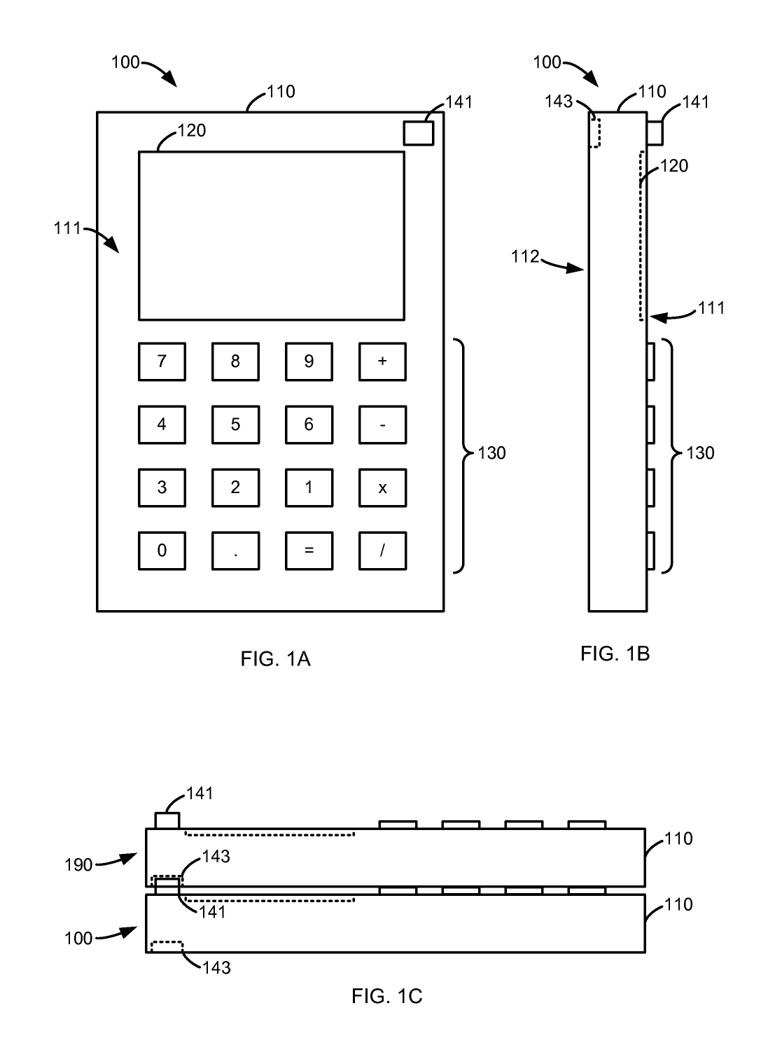

FIGS. 1A and 1B are illustrations of a calculator, according to an implementation. FIG. 1C is an illustration of two calculators according to FIGS. 1A and 1B in a stacked configuration, according to an implementation. Calculator 100 includes housing 110, display 120, keypad 130, coupler 141, and coupler 143. Display 120, keypad 130, and coupler 141 are at face 111 of calculator 100. Coupler 143 is at face 112 of calculator 100. Face 111 can be referred to as a top face or a front face of calculator 100. Face 112 can be referred to as a bottom face or a back face of calculator 100. Calculator 190 is similar to calculator 100.

Display 120 is a device such as a liquid crystal display (“LCD”) at which symbols are displayed. For example, letters, numbers, and/or arithmetic symbols can be displayed at display 120. Keypad 130 is an input device of calculator 100. That is, input signals for calculator 100 are generated at keypad 130. For example, as illustrated in FIG. 1A, keypad 130 includes a group of buttons.

Calculator 100 can be coupled to other calculators via couplers 141 and 143 and corresponding (or complementary) couplers at those other calculators. That is, calculator 100 can be coupled to a first calculator via coupler 141 and to a second calculator via coupler 143. In other implementations, calculator 100 can include more couplers than illustrated in FIGS. 1A, 1B, and 1C. For example, calculator 100 can include two or more additional couplers at face 111 of calculator 100 and two or more additional couplers at face 112 of calculator 100. In some implementations, some couplers are used to exchange symbols between or among calculators operatively coupled one to another via the couplers and some couplers are used to distribute, for example, an operational voltage or a reference signal such as a ground signal.

Calculator 100 sends and/or receives symbols (e.g., signals or groups of signals such as electrical or optical signals) to and/or from other calculators to which it is coupled via couplers 141 and 143 and complementary couplers at those other calculators. In other words, calculator 100 and the other calculators exchange signals via couplers 141 and 143 and complementary couplers at the other calculators. Couplers 141 and 143 can include, for example, electrically-conductive pins, receptacles, pads, contacts, other electrical couplers, optical gratings, lenses, mirrors, fibers, or other optical couplers.

As illustrated in FIG. 1C, calculator 100 can be coupled to calculator 190 in a stacked configuration via coupler 141 of calculator 100 and coupler 143 of calculator 190. In other words, coupler 143 of calculator 190 forms a complementary fit with coupler 141 of calculator 100 when calculator 190 is placed on top of calculator 100. That is, coupler 141 of calculator 100 is configured to interface (or join or mate) with coupler 143 of calculator 190. Signals such as electrical or optical signals can be exchanged between calculators 100 and 190 via coupler 141 of calculator 100 and coupler 143 of calculator 190.

Because coupler 141 of calculators 100 and 190 is opposite (i.e., on opposite sides of calculators 100 and 190) coupler 143 of calculators 100 and 190, respectively, coupler 143 of calculator 190 is coupled to (or forms a complementary fit with) coupler 141 of calculator 100 when calculators 100 and 190 are stacked as or are in the stacked configuration illustrated in FIG. 1C. That is, calculators 100 and 190 are operatively coupled one to another via coupler 141 of calculator 100 and coupler 143 of calculator 190 when face 111 of calculator 100 is adjacent to face 112 of calculator 190. Said differently, calculators 100 and 190 are in communication one with another (i.e., can exchange signals or symbols) via coupler 143 of calculator 190 and coupler 141 of calculator 100 when calculators 100 and 190 are stacked such that coupler 143 of calculator 190 forms a complementary fit with coupler 141 of calculator 100.

In some implementations, housing 110 of calculator 100 and housing 110 of calculator 190 can be secured one to another using a compression fit, a friction fit, a snap fit, a magnetic coupling, and/or an annular lock. For example, housing 110 of calculator 100 and/or housing 110 of calculator 190 can include features such as protrusions, ridges, flanges, indentations, magnets, and/or other features (not shown) via which housing 110 of calculator 100 and housing 110 of calculator 190 can be coupled one to another. In other words, housing 110 of calculator 100 and housing 110 of calculator 190 can be secured one to another in the stacked configuration illustrated in FIG. 1C.

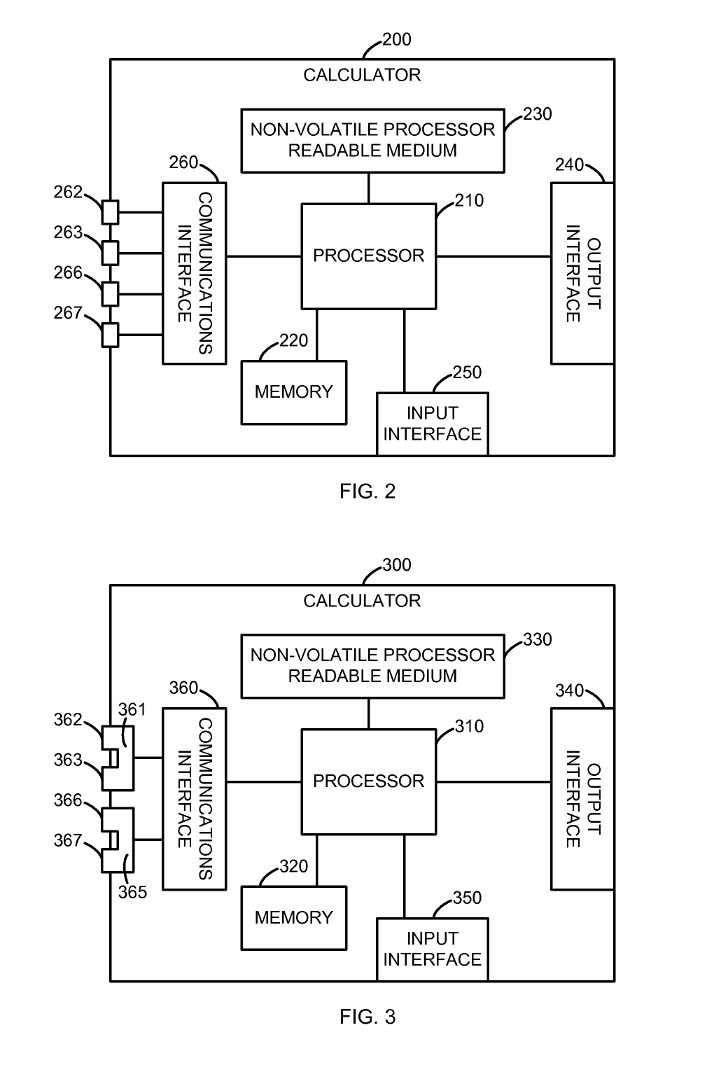

FIG. 2 is a schematic block diagram of a calculator, according to an implementation. Calculator 200 includes processor 210, memory 220, non-volatile (or non-transient) processor-readable medium 230, output interface 240, input interface 250, and communications interface 260. In some implementations, one or more of memory 220, non-volatile processor-readable medium 230, output interface 240, input interface 250, and communications interface 260 can be integrated at processor 210.

Processor 210 is any of a variety of processors. For example, processor 210 can be a general-purpose processor or an application-specific processor and can be implemented as a hardware module or a software module hosted at a hardware module. A hardware module can be, for example, a microprocessor, a microcontroller, an application-specific integrated circuit (“ASIC”), a programmable logic device (“PLD”) such as a field programmable gate array (“FPGA”), and/or other electronic circuits that perform operations. A software module can be, for example, instructions, commands, and/or codes stored at a memory and executed (or hosted) at another processor. Such a software module can be defined using one or more programming languages such as Java™, C++, C, an assembly language, a hardware description language, and/or another suitable programming language. For example, a processor can be a virtual machine hosted at a computer server including a microprocessor and a memory.

In some implementations, processor 210 can include multiple processors. For example, processor 210 can be a microprocessor including multiple processing engines (e.g., computation, algorithmic, or thread cores). As another example, processor 210 can be a computing device including multiple processors with a shared clock, memory bus, input/output bus, and/or other shared resources.

Memory 220 includes data and/or instructions or codes (e.g., computer codes or object codes) defining software modules (or software applications) that are executed by processor 210 during operation of calculator 200. For example, memory 220 can include instructions that define an operating system, device drivers, a communications protocol stack, a database (i.e., a group of related data sets), and/or operational parameters such as an identifier of calculator 200 or a list of disabled functionalities of calculator 200.

As a specific example, memory 220 can include an operating system for calculator 200 that is hosted at processor 210 and includes a master mode and a slave mode. For example, calculator 200 can be configured to operate or function as a master device in communication with other calculators via couplers 262, 263, 266, and/or 267. That is, calculator 200, for example, sends commands to other calculators and controls a communications protocol via which calculator 200 communicates with the other calculators when in the master mode. In the slave mode, calculator 200 accesses or receives commands from a calculator in a master mode and processes those commands. In other words, in the slave mode, calculator 200 receives commands from a calculator in the master mode and performs actions associated with or described by those commands.

Non-volatile processor-readable medium 230 includes data and/or computer codes or instructions that are copied (or loaded) into memory 220 during a boot or initialization sequence of calculator 200. That is, processor 210 (or another module such as a direct memory access module or basic input/output system (“BIOS”) module (not shown) of calculator 200) can copy the data and/or instructions included at non-volatile processor-readable medium 230 to memory 220, and processor 210 can later access those data and/or instructions during operation of calculator 200 at memory 220.

Examples of processor-readable media include, but are not limited to: magnetic storage media such as a hard disk, a floppy disk, and/or magnetic tape; optical storage media such as a compact disc (“CD”), a digital video disc (“DVDs”), a compact disc read-only memory (“CD-ROM”), and/or a holographic device; magneto-optical storage media; non-volatile memory such as read-only memory (“ROM”), programmable read-only memory (“PROM”), erasable programmable read-only memory (“EPROM”), electronically erasable read-only memory (“EEPROM”), and/or FLASH memory; and random-access memory (“RAM”). Examples of computer code include, but are not limited to, micro-code or micro-instructions, machine instructions, such as produced by a compiler, and files containing higher-level instructions that are executed by a computer using an interpreter. For example, an implementation may be realized or implemented using Java™, C++, or other object-oriented programming language and development tools. Additional examples of computer code include, but are not limited to, control signals, encrypted code, and compressed code.

In some implementations, non-volatile processor-readable medium 230 can be external to or removable from calculator 200. For example, non-volatile processor-readable medium 230 can include a Universal Serial Bus™ (“USB”) interface (or interface module) and non-volatile processor-readable medium 230 can be FLASH memory device with a USB interface. Alternatively, for example, non-volatile processor-readable medium 230 can be, for example, a Secure Digital™ (“SD”) memory device.

Output interface 240 is a module via which processor 210 can provide data (e.g., numbers, letters, and/or symbols such as arithmetic symbols) to a display. For example, output interface 240 can be a display driver. In some implementations, output interface 240 includes a display. In other words, output interface can include a display driver and a display.

Input interface 250 is a module via which processor 210 receives input signals, symbols, or data. Said differently, input interface 250 provides input to processor 210. For example, input interface 250 can include a keypad and circuitry to provide signals to processor 210 when a user depresses a key (or button) of the keypad. In some implementations, input interface 250 and output interface 240 can be integrated. For example, calculator 200 can include a touch-sensitive display at which information can be output and from which input can be generated (i.e., in response to contact such as contact from a user's finger or a stylus at the touch-sensitive display).

Communications interface 260 is a module via which processor 210 communicates with (i.e., transmit symbols representing data to and receive such symbols from) other processors and/or calculators. Communications interface 260 can be, for example, a Two-Wire interface module, a Serial Peripheral Interface module, a One-Wire interface module, and/or other modules. Said differently, communications interface 260 implements a protocol via which calculator 200 communicates with other calculators. More specifically, processor 210 communicates with other calculators via communications interface 260 and couplers 262, 263, 266, and 267.

Moreover, communications interface 260 can have a master mode and a slave mode. In other words, communications interface 260 can be configured as a master to control a communications protocol via which calculator 200 communicates with other calculators, or as a slave that responds to the communications protocol controlled by a master. As a specific example, communications interface 260 can be a Two-Wire interface module. A master mode of the operating system of calculator 200 can be selected or activated and communications interface 260 can be configured in a master mode as a result. In the master mode, communications interface 260 generates a clock signal at coupler 267 and sends commands to other calculators (i.e., calculators stacked under calculator 267) via coupler 263. The operating systems and communications interfaces of the other calculators are in slave modes and use the clock signal generated by calculator 200 at coupler 267 to synchronize with and interpret the commands sent via coupler 263.

Couplers 262, 263, 266, and 267 are in communication with communications interface 260 and are configured to form complementary fits with couplers of other calculators. That is, calculator 200 can communicate with other calculators via communications interface 260, couplers 262, 263, 266, and 267, communications interfaces at the other calculators, and couplers at the other calculators. Furthermore, couplers 262, 263, 266, and 267 are operatively coupled to processor 210 via communications interface 260. For example, processor 210 can access signals received at couplers 262, 263, 266, and 267 (or data derived from those signals) via communications interface 260 and can send data at couplers 262, 263, 266, and 267 via communications interface 260.

Couplers 262, 263, 266, and 267 can each be an input coupler, an output coupler, or a bi-directional (input and output) coupler. For example, if communications interface 260 is a One-Wire interface module, couplers 262, 263, 266, and 267 can each be bi-directional couplers. That is, symbols are sent and received at couplers 262, 263, 266, and 267. Alternatively, for example, if communications interface 260 is a Two-Wire interface module and is in a master mode, coupler 262 can be a bi-directional coupler for data exchange and coupler 263 can be an output coupler for a clock signal. In other implementations, calculator 200 can include more or fewer couplers than illustrated in FIG. 2. For example, calculator 200 can include more or fewer couplers than illustrated in FIG. 2 to support a protocol via which calculator 200 communicates (i.e., exchanges signals representing data) with other calculators. In other words, calculator 200 can communicate with other calculator via one or more couplers.

FIG. 3 is a schematic block diagram of a calculator, according to another implementation. Calculator 300 is similar to calculator 200 and includes processor 310, memory 320, non-volatile processor-readable medium 330, output interface 340, input interface 350, and communications interface 360. Processor 310, memory 320, non-volatile processor-readable medium 330, output interface 340, input interface 350, and communications interface 360 are each similar, respectively, to processor 210, memory 220, non-volatile processor-readable medium 230, output interface 240, input interface 250, and communications interface 260 discussed above in relation to FIG. 2.

Calculator 300 includes pass-though couplers 361 and 365. Pass-through coupler 361 includes portion 362 and 363. A signal received at portion 362 is passed through pass-though coupler 361 to portion 363. Similarly, a signal received at portion 363 is passed through pass-though coupler 361 to portion 362. Moreover, a signal output from communications interface 260 to pass-through coupler 361 is output at each of portions 362 and 363. Pass-through coupler 365 includes portion 366 and portion 367 and operates similarly to pass-through coupler 361.

Pass-through couplers 361 and 365 can be electrical or optical devices. For example, pass-through coupler 361 can be an electrically-conductive component (e.g., a metal plug or rod) within a housing of calculator 300 that is coupled to communications interface 260 and has two ends—portions 362 and 363—extending out of the housing. As another example, pass-through coupler 361 can include two electrically-conductive couplers (one each at portions 362 and 363) and an electrically-conductive link such as a wire between the two conductors. Alternatively, for example, pass-through coupler 361 can be an optical device or group of optical devices that define an optical path (i.e., an optical signal propagation path) between portions 362 and 363 and an optical path between pass-though coupler 361 and communications interface 360. As a more specific example, pass-through coupler 361 can include two optical couplers (one each at portions 362 and 363) and a grating to divert a portion of optical energy received at portion 362 or 363 to communications interface 361.

Each of portions 362, 363, 366, and 367 are couplers of calculator 300. That is, calculator 300 can be coupled to other calculators via portions (or couplers) 362, 363, 366, and 367 and complementary couplers at the other calculators. As an example, calculator 300 can be coupled to a first calculator via portion 362 of pass-through coupler 361 and to a second calculator via portion 363 of pass-through coupler 361. Signals received from the first calculator at portion 362 are received at communications interface 360 and are passed through pass-through coupler 361 to the second calculator. Thus, signals are exchanged among calculator 300, the first calculator, and the second calculator operate as though a common bus because pass-through coupler 361 implements a bus architecture (i.e., multiple devices such as calculators connected to a common signal path) for calculators operatively coupled to pass-through coupler 361. Moreover, if the first calculator and/or the second calculator are coupled to calculator 300 with pass-through couplers, additional calculators operatively coupled to the pass-through coupler of the first calculator and/or the pass-through coupler of the second calculator are also connected to the common bus.

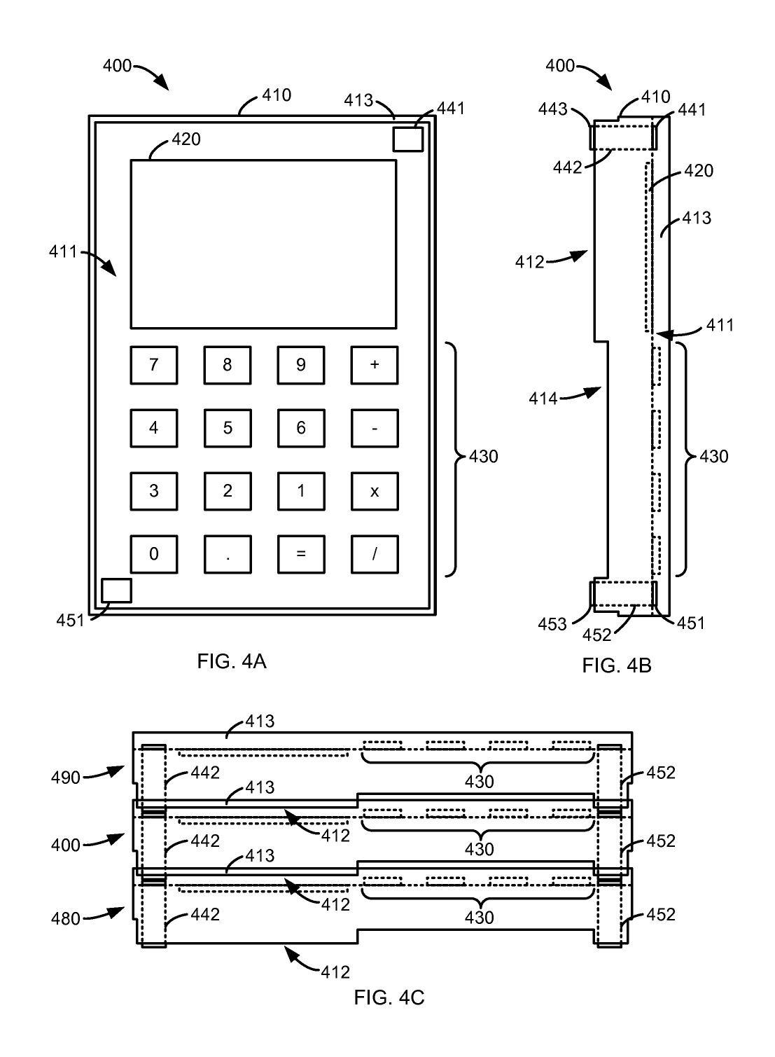

For example, FIGS. 4A and 4B are illustrations of a calculator, according to an implementation. FIG. 4C is an illustration of three calculators according to FIGS. 4A and 4B in a stacked configuration, according to an implementation. Calculator 400 includes housing 410, flange 413, cutout 414, display 420, keypad 430, coupler 441, coupler 443, coupler 451, and coupler 453. Housing 410, display 420, keypad 430, and couplers 441, 443, 451, and 453 are similar to housing 110, display 120, keypad 130, and couplers 141 and 143, respectively, discussed above in relation to FIGS. 1A, 1B, and 1C. Calculators 480 and 490 are similar to calculator 400.

Flange 413 protrudes from face 411 and circumscribes (or bounds) face 411. Additionally, flange 413 is configured to receive face 412 of another calculator to reduce relative motion of calculator 400 and the other calculator. That is, when the two calculators are in a stacked configuration, flange 413 of calculator 400 limits movement of the other calculator relative to calculator 400 to prevent decoupling of the couplers of the two calculators. For example, as illustrated in FIG. 4C, face 412 of calculator 490 is received within flange 413 of calculator 400.

Cutout 414 is sized and positioned at face 412 of calculator 400 to avoid interaction between face 412 of calculator 400 and the keypad of another calculator on which calculator 400 is stacked. For example, as illustrated in FIG. 4C, cutout 414 of calculator 400 prevents face 412 of calculator 400 from contacting (e.g., depressing) buttons of keypad 430 of calculator 480.

As illustrated in FIGS. 4B and 4C, couplers 441 and 443 are portions of pass-through coupler 442. Similarly, couplers 451 and 453 are portions of pass-through coupler 452. Thus, when multiple calculators similar to calculator 400 are in a stacked configuration, the pass-through couplers of each calculator collectively define a common signal path or bus among the calculators. Accordingly, each of the calculators can receive signals sent by any other calculator of the calculators.

More specifically, as illustrated in FIG. 4C, calculators 400, 480, and 490 are in a stacked configuration. Calculator 400 is coupled to calculator 490 via coupler 443 of pass-through coupler 442 of calculator 490 and coupler 441 of pass-through coupler 442 of calculator 400, and via coupler 453 of pass-through coupler 452 of calculator 490 and coupler 451 of pass-through coupler 452 of calculator 400. Similarly, calculator 400 is coupled to calculator 480 via coupler 443 of pass-through coupler 442 of calculator 400 and coupler 441 of pass-through coupler 442 of calculator 480, and via coupler 453 of pass-through coupler 452 of calculator 400 and coupler 451 of pass-through coupler 452 of calculator 480.

Furthermore, pass-through coupler 442 of each of calculators 400, 480, and 490 define a bus to which each of calculators 400, 480, and 490 are coupled. Pass-through coupler 452 of each of calculators 400, 480, and 490 similarly define another bus to which each of calculators 400, 480, and 490 are coupled. Accordingly, a signal provided to calculator 490 from calculator 400 via coupler 451 of calculator 400 and coupler 453 of calculator 490 is also provided to calculator 480 via pass-through coupler 452 and coupler 453 of calculator 400 and coupler 451 of calculator 480. Thus, each of the stacked calculators (i.e., calculators 400, 480, and 490 as illustrated in FIG. 4C) are in communication one with another. That is, calculator 490 is in communication with calculator 480 via the bus defined by, for example, pass-through coupler 442 of each of calculators 400, 480, and 490 even though calculator 490 is not directly coupled to calculator 480 (i.e., calculator 400 is between calculators 480 and 490 in the stacked configuration illustrated in FIG. 4C).

Implementations such as the example illustrated in FIG. 4C can be particularly beneficial to applications in which it is desirable that multiple calculators communicate one with another. As a specific example, such an implementation can be beneficial in a classroom setting to communicate with students' calculators prior to and/or after an examination. Each of the students' calculators can be configured as a slave calculator (or slave) (or put into a slave mode or configuration). For example, each student can select the slave mode from a menu of that student's calculator. When configured as slaves, the calculators accept commands from a master calculator (or master). That is, the slave calculators access commands provided by the master calculator and execute those commands. Such commands, when executed, cause the slave calculators to, for example, alter a value of an operational parameter to enable or disable a functionality, enable or disable access to data such as files, store a data set received from the master at a memory, enable or disable compilation or generation of an operation history (e.g., a listing of operations, inputs, outputs, functionalities, and/or other parameters accessed, changed, and/or executed at a calculator), provide a data set from a memory to the master, or provide an operation history to the master.

After the students' calculators have been configured as slaves, the students' calculators can be stacked (or placed in a stacked configuration). A teacher's calculator, for example, can be configured as a master by the teacher's selection of a master mode or configuration from a menu of the teacher's calculator. When configured as a master (or master calculator), the teacher's calculator provides commands to and receives responses from the students' calculators (the slaves). The teacher's calculator can then be placed on the top of the stack of calculators, and the teacher can configure the students' calculators (i.e., send commands to the students' calculators to cause the students' calculators to, for example, alter a value of an operational parameter to enable or disable a functionality, to enable or disable access to data such as files, store a data set received from the master at a memory, enable or disable compilation or generation of an operation history), provide a data set to the students' calculators, and/or access data sets, operation histories, or other information at the students' calculators by sending commands to the students' calculator via the teacher's calculator.

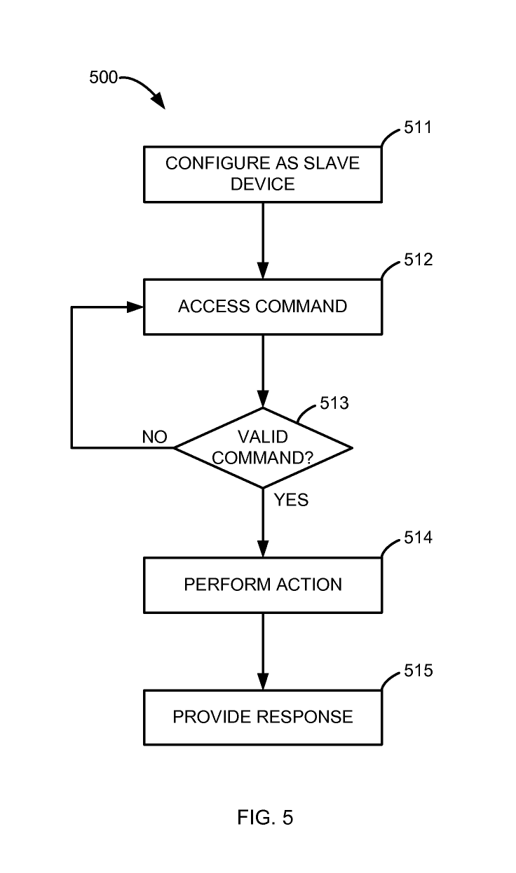

FIG. 5 is a flowchart of a process to access commands from a calculator configured as a master, according to an implementation. Process 500 can be implemented as a hardware module, as a software module hosted at a computing device, or a combination thereof. For example, process 500 can be implemented as application-specific circuitry or as a software module including instructions stored at a memory and executed at a processor in communication with the memory. More specifically, for example, process 500 can be implemented at a calculator.

The calculator implementing process 500 is configured as a slave device (e.g., a slave calculator) at block 511. For example, a switch of the calculator can be engaged to a slave position or a slave mode can be activated by selecting the slave mode in a menu via a display and a keypad of the calculator. The calculator then accesses a command at block 512. In some implementations, the command can be accessed when it is received from a master device (e.g., a master calculator). That is, the calculator can receive the command at block 512. As a specific example, the calculator can have an identifier such as a device identifier (e.g., a static identifier) or a network identifier (e.g., a dynamic identifier assigned to the calculator or selected by the calculator when the calculator is placed in a stacked configuration with other calculators). The master device sends a command including the identifier of the calculator, and the calculator receives the command. That is, the master device sends signals representing the command and identifier via one or more couplers such as, for example, pass-through couplers, at the master device, the calculator, and other calculators in a stacked configuration, and the calculator receives those signals at a coupler of the calculator.

As an alternative, for example, the calculator can poll the master device for a command. For example, the calculator can request a command from the master device and receive a command in response if the master has a command for the calculator. As another example, the calculator can access a memory location or register of the master device at which commands are stored, and can access a command at the memory location or register if a command is available.

After the calculator accesses a command, the calculator then determines whether the command is a valid command at block 513. For example, the command can include a command identifier, one or more parameter values, and/or a checksum. The calculator can, for example, perform a lookup in a table or database of value command identifiers, can validate parameter values (e.g., verify that the parameter values are within an allowed range or are of an allowed type), and/or can verify the checksum by generating a checksum of the command identifier and any parameter values and comparing that checksum with the checksum included in the command to determine whether the command is value. If the command is not valid (e.g., a command identifier is not recognized or included in a table of command identifier, a parameter value is out of range, or a checksum generated by the calculator does not match a checksum of the command), the calculator returns to block 512 to access another command.

If the command is valid, the calculator executes the command. For example, as illustrated in FIG. 5, the calculator performs an action based on the command at block 514 (e.g., alters a value of a configuration parameter or accesses an operation history of the calculator), and provides a response to the master device at block 515 (e.g., a status response such as success or failure or a data set or operation history of the calculator). The action can be any of a variety of actions including, for example, altering a value of an operational parameter to enable or disable a functionality, enabling or disabling access to data such as files, storing a data set received from the master at a memory, enabling or disabling compilation or generation of an operation history, providing a data set from a memory to the master, or providing an operation history to the master.

Process 500 can include additional or fewer blocks than those illustrated in FIG. 5. For example, in some implementations, a calculator configured as a slave does not provide responses to a master device. As another example, in some embodiments, a slave mode is a default configuration of the calculator and block 511 is excluded. Additionally, one or more blocks can be rearranged. As an example, a calculator can provide a response such as an acknowledgement of a command or an indication that a command was determined to not be valid before the command is executed or before execution of the command is complete. In other words, blocks 514 and 515, for example, can be reversed. Furthermore, although process 500 is discussed above with reference to an example environment including a calculator, process 500 is applicable within other environments.

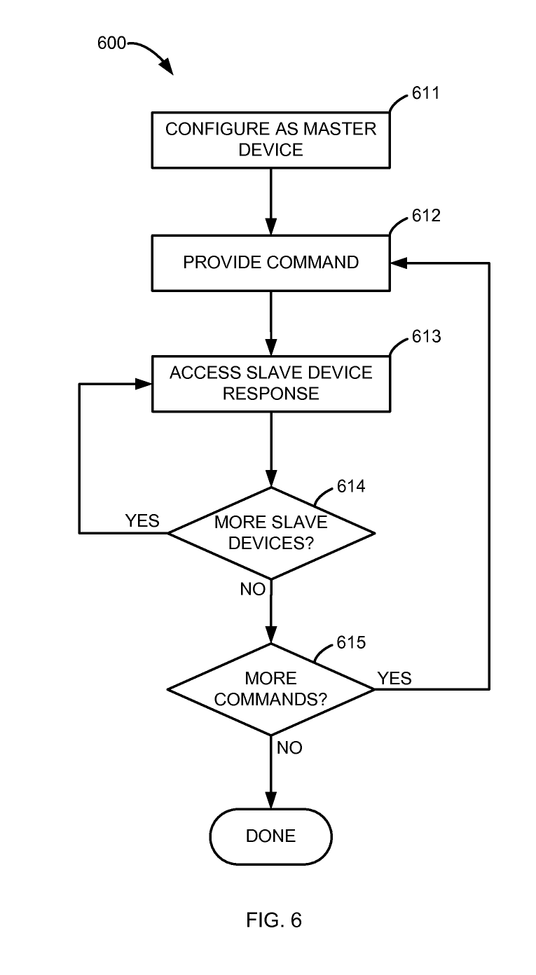

FIG. 6 is a flowchart of a process to provide commands to a calculator configured as a slave, according to an implementation. Process 600 can be implemented as a hardware module, as a software module hosted at a computing device, and/or as a combination of a hardware module and a software module. For example, process 600 can be implemented as application-specific circuitry or as a software module including instructions stored at a memory and executed at a processor in communication with the memory. More specifically, for example, process 600 can be implemented at a calculator.

The calculator implementing process 600 is configured as a master device (e.g., a master calculator) at block 611. For example, a switch of the calculator can be engaged to a master position or a master mode can be activated by selecting the master mode in a menu via a display and a keypad of the calculator. A command is then provided at block 612. For example, a user of the calculator can input or select a command or group of command (e.g., a command script) and a command is sent to one or more slave devices at block 612. That is, the calculator sends signals representing the command and, for example, an identifier of a slave device via one or more couplers such as, for example, pass-through couplers, at the calculator and other calculators (i.e., slave devices) in a stacked configuration. Alternatively, for example, the calculator can wait at block 612 until a slave device requests (or polls for) a command, and the calculator can provide a command to the slave device in response to the request.

In some implementations, the calculator does not send the command to the slave device or slave devices. Rather, for example, the calculator provides the command by storing the command at a location (e.g., a register or memory location) at which the slave device or slave devices can access the command. Thus, a command can be provided to a slave device by sending the command to the slave device (or pushing the command to the slave device from the calculator), or by storing the command at a location at which the slave device can access or retrieve the command (or the slave device can pull the command from the calculator).

After providing the command, the calculator accesses a response from a slave device at block 613. The calculator can receive the response or can retrieve the response. That is, the slave device can push the response to the calculator or the calculator can pull the response from the slave device. Additionally, if there are additional slave devices at block 614, the calculator returns to block 613 to access a response from another slave device.

If there are no additional slave devices at block 614, the calculator determines whether there are additional commands at block 615. For example, the calculator can wait a block 615 for additional commands from a user or can determine whether a command script includes additional commands. If there are more commands at block 615, the calculator returns to block 612 to provide another command. If there are no more commands at block 615, process 600 is complete.

Process 600 can include additional or fewer blocks than those illustrated in FIG. 6. Additionally, one or more blocks can be rearranged. For example, accessing responses from clients can occur in parallel with other blocks of process 600. That is, a calculator implementing process 600 can access responses from slave devices asynchronously with respect to other blocks of process 600. Additionally, in some implementations, slave devices do not provide responses for some commands or all commands. Thus, block 613 and/or block 614 can be excluded at process 600 or during some iterations from block 612 and 615. Furthermore, although process 600 is discussed above with reference to an example environment including a calculator, process 600 is applicable within other environments.

While certain implementations have been shown and described above, various changes in form and details may be made. For example, although implementations have been described with two or three calculators in a stacked configuration, additional calculators can be included in stacked configurations. Moreover, implementations discussed above in relation to calculators stacked vertically (i.e., the top face of one calculator is adjacent to the bottom face of another calculator in the stacked configuration) are applicable to implementations in which calculators are stacked horizontally (i.e., one side face of one calculator is adjacent to a side face of another calculator in the stacked configuration). As another example, processes, features, components, and/or properties described in relation to one implementation can be useful in other implementations. Furthermore, it should be understood that the systems and methods described herein can include various combinations and/or sub-combinations of the components and/or features of the different implementations described. Thus, features described with reference to one or more implementations can be combined with other implementations described herein.

What is claimed is:

1. A calculator, comprising:
a first coupler to form a complementary fit with a coupler of a first calculator, the first coupler operable to exchange signals with the coupler of the first calculator;
a second coupler to form a complementary fit with a coupler of a second calculator, the second coupler operable to exchange signals with the coupler of the second calculator; and
a processor operatively coupled to the first coupler and to the second coupler.

2. The calculator of claim 1, further comprising:
a communications interface having a master mode and a slave mode, the communications interface in communication with the processor and operatively coupled to the first coupler and the second coupler,
the communications interface is operable to receive commands via the first coupler and via the second coupler if the processor is configured in the slave mode.

3. The calculator of claim 1, further comprising:
a communications interface having a master mode and a slave mode, the communications interface in communication with the processor and operatively coupled to the first coupler and the second coupler,
the communications interface is operable to send commands via the first coupler and via the second coupler if the processor is configured in the master mode.

4. The calculator of claim 1, further comprising:
a communications interface having a master mode and a slave mode, the communications interface in communication with the processor and operatively coupled to the first coupler and the second coupler,
the processor operable to receive a command via the communications interface and to send the command via the communications interface.

5. The calculator of claim 1, further comprising:
a communications interface having a master mode and a slave mode, the communications interface in communication with the processor and operatively coupled to the first coupler and the second coupler,
the processor operable to receive a command via the communications interface and to send the command via the communications interface if the command does not include a device identifier of the calculator.

6. The calculator of claim 1, further comprising:
a first face including the first coupler; and
a second face including the second coupler, the second face opposite the first face.

7. The calculator of claim 1, wherein the first coupler and the second coupler are operatively coupled one to another.

8. The calculator of claim 1, wherein the first coupler is a first portion of a pass-through coupler and the second coupler is a second portion of the pass-through coupler, the processor operatively coupled to the pass-through coupler.

9. A calculator system, comprising:
a first calculator including a first coupler, a second coupler, a first face, and a second face, the first coupler of the first calculator at the first face of the first calculator and the second coupler of the first calculator at the second face of the first calculator; and
a second calculator including a first coupler, a second coupler, a first face, and a second face, the first coupler of the second calculator at the first face of the second calculator and the second coupler of the second calculator at the second face of the second calculator,
the first coupler of the first calculator configured to form a complementary fit with the second coupler of the second calculator.

10. The calculator system of claim 9, wherein:
the first calculator is in a master mode to provide commands to the second calculator; and
the second calculator is in a slave mode to execute the commands.

11. The calculator system of claim 9, wherein:
the first coupler and the second coupler of the first calculator are electrically conductive; and
the first coupler and the second coupler of the second calculator are electrically conductive.

12. The calculator system of claim 9, wherein:
the first coupler of the first calculator is a first portion of a first pass-through coupler and the second coupler of the first calculator is a second portion of the first pass-through coupler; and
the first coupler of the second calculator is a first portion of a second pass-through coupler and the second coupler of the second calculator is a second portion of the second pass-through coupler.

13. The calculator system of claim 9, wherein:
the first coupler and the second coupler of the first calculator define a first optical path; and
the first coupler and the second coupler of the second calculator define a second optical path.

14. The calculator system of claim 9, wherein:
the first face of the first calculator is opposite the second face of the first calculator; and
the first face of the second calculator is opposite the second face of the second calculator.

15. A calculator, comprising:
a first pass-through coupler to concurrently form a complementary fit with a first coupler of a first calculator and a complementary fit with a first coupler of a second calculator, the first pass-through coupler operable to exchange signals with the first coupler of the first calculator and the first coupler of the second calculator; and
a second pass-through coupler to concurrently form a complementary fit with a second coupler of the first calculator and a complementary fit with a second coupler of the second calculator.

16. The calculator of claim 15, further comprising:
a top face; and
a bottom face opposite the top face, the first pass-through coupler includes a first portion at the top face and a second portion at the bottom face,
the second pass-through coupler includes a first portion at the top face and a second portion at the bottom face.

17. The calculator of claim 15, further comprising:
a processor operatively coupled to the first pass-through coupler to receive commands via the first pass-through coupler,
the processor configured to disable a functionality in response to a command from the commands.

18. The calculator of claim 15, further comprising:
a processor operatively coupled to the first pass-through coupler to receive commands via the first pass-through coupler; and
a memory operatively coupled to the processor, the processor configured to store a data set at the memory in response to a command from the commands.

19. The calculator of claim 15, further comprising:
a processor operatively coupled to the first pass-through coupler to receive commands via the first pass-through coupler; and
a memory operatively coupled to the processor, the processor configured to output a data set from the memory via the first pass-through coupler in response to a command from the commands.

20. The calculator of claim 15, further comprising:
a processor operatively coupled to the first pass-through coupler to receive commands via the first pass-through coupler,
the processor configured to output an operation history via the first pass-through coupler in response to a command from the commands.
